(19) United States
(12) Patent Application Publication
(10) Pub. No.: US 2020/0335292 A1
(43) Pub. Date: Oct. 22, 2020

(54) Rocker Switch

(71) Applicants: Defond Electech Co., Ltd., Dongguan City (CN); Defond Components Limited, Chaiwan (HK)

(72) Inventors: Xiao Yu Lai, Dongguan City (CN); Hua Lin Pan, Dongguan City (CN); Bang Yan Yang, Dongguan City (CN); Dong Wang, Dongguan City (CN)

(73) Assignees: Defond Electech Co., Ltd.; Defond Components Limited

(21) Appl. No.: 16/842,350

(22) Filed: Apr. 7, 2020

(30) Foreign Application Priority Data
Apr. 22, 2019 (CN) 201920557310.1

(51) Int. Cl. H01H 23/14; H01H 23/16

(52) U.S. Cl. CPC H01H 23/14; H01H 23/16

(57) ABSTRACT

A rocker switch (3) includes a housing (1), a button (2), a rocker (3), a dynamic contact plate (4), and a first terminal (51) and a second terminal (52) installed in the housing (1). The button (2) is hinged with the housing (1); the top of the rocker (3) is connected to the bottom of the button (2); the rocker (3) and the button (2) are linked with each other; the bottom side of the dynamic contact plate (4) presses the second terminal (52); the rocker (3) is provided for turning the dynamic contact plate (4) to rotate; and an end of the dynamic contact plate (4) is provided for connecting the first terminal (51). This rocker switch (3) of this invention overcomes the problem of unable to miniaturize the switch.

### FIELD OF INVENTION

The present invention relates to the technical field of electronic switches, in particular to a rocker switch.

### BACKGROUND OF INVENTION

### Description of the Related Art

In general, a conventional rocker switch has a movable contact which is biased along a direction with respect to a switch position, and held at another switch position by magnetism, so that it is necessary to install an electromagnet in the switch. As a result, the switch cannot be miniaturized.

### SUMMARY OF THE INVENTION

In view of the aforementioned drawback and deficiency of the prior art, it is a primary object of the present invention to provide a rocker switch to overcome the issue of the conventional rocker switch that cannot be miniaturized.

To achieve the aforementioned and other objectives, the present invention discloses a rocker switch with a housing, and the rocker switch comprises a button, rocker, a dynamic contact plate, and a first terminal and a second terminal installed in the housing, and the button is hinged with the housing, and the top of the rocker is coupled to the bottom of the button, and the rocker and the button are linked with each other, and a bottom side of the dynamic contact plate presses at the second terminal, and the rocker is provided for turning the dynamic contact plate to rotate, and an end of the dynamic contact plate is provided for coupling the first terminal.

Wherein, the bottom of the rocker presses at an end surface of the dynamic contact plate, and the other end surface of the dynamic contact plate has a notch, and the notch presses at the top of the second terminal.

Wherein, the rocker comprises a rocking shaft and a spring and prop, and the top of the rocking shaft is coupled to the bottom of the button, and the rocking shaft and the button are linked with each other, and the rocking shaft has a chute, and the prop is slidably coupled to the chute, and the spring is installed between the chute and the prop, and an end of the prop presses at an end surface of the dynamic contact plate.

Wherein, the prop is in a hollow shape, and both ends of the spring are coupled to the bottom end surface of the chute and the inner sidewall of the prop.

Wherein, the top of the first terminal has a first static contact, and an end of the dynamic contact plate has a first dynamic contact provided for contacting with the first static contact.

Wherein, the rocker switch further comprises a third terminal, and the other end of the dynamic contact plate is provided for coupling the third terminal.

Wherein, the top of the third terminal has a second static contact, and the other end of the dynamic contact plate is provided for contacting with the second static contact.

Wherein, a silicone sealing ring is installed between the rocker and the housing.

The present invention has the following advantageous effect:

To overcome the issue of the rocker switch that cannot be miniaturized, the present invention provides a rocker switch, wherein the button is hinged with the housing, and the rocker is linked with the button, and the rocker turns the dynamic contact plate when the button is pressed, and the top of the button moves obliquely in a direction towards the first terminal in a disconnected status. Now, the rocker presses at the other end of the dynamic contact plate, so that an end of the dynamic contact plate is separated from the first terminal. When the button is pressed in a direction away from the first terminal, the top of the button rotates in a direction away from the first terminal while driving the rocker to swing and press at an end of the dynamic contact plate, so that the dynamic contact plate also swings, and an end of the dynamic contact plate touches the first terminal to set the rocker switch to a connected status. The rocker switch of the present invention can control the connection and disconnection without requiring a relay, so as to overcome the issue of the conventional rocker switch that cannot be miniaturized.

### BRIEF DESCRIPTION OF THE DRAWINGS

The present invention is further described by means of an embodiment together with the related drawings. It is noteworthy that these drawings are provided for the purpose of illustrating the present invention, but not intended for limiting the scope of the invention, and a person having ordinary skill of art may obtain other drawings according to the these drawings without requiring further creative effort.

FIG. 1 is a perspective view of a first embodiment of the present invention;

FIG. 2 is an exploded view of the first embodiment of the present invention;

FIG. 3 is a cross-sectional view of the first embodiment of the present invention in a disconnected status;

FIG. 4 is a cross-sectional view of the first embodiment of the present invention in a connected status;

FIG. 5 is a perspective view of a second embodiment of the present invention;

FIG. 6 is an exploded view of the second embodiment of the present invention;

FIG. 7 is a cross-sectional view of the second embodiment of the present invention in a status; and

FIG. 8 is a cross-sectional view of the second embodiment of the present invention in another status.

Brief Description of Numerals Used in the Drawings: 1: Housing; 2: Button; 3: Rocker; 31: rocking shaft; 32: Spring; 33: prop; 34: chute; 4: Dynamic contact plate; 41: notch; 42: First dynamic contact; 43: Second dynamic contact; 51: First terminal; 52: Second terminal; 53: Third terminal; 54: First static contact; 55: Second static contact; 6: silicone sealing ring.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention. It is intended that the embodiments and figures disclosed herein are to be considered illustrative rather than restrictive.

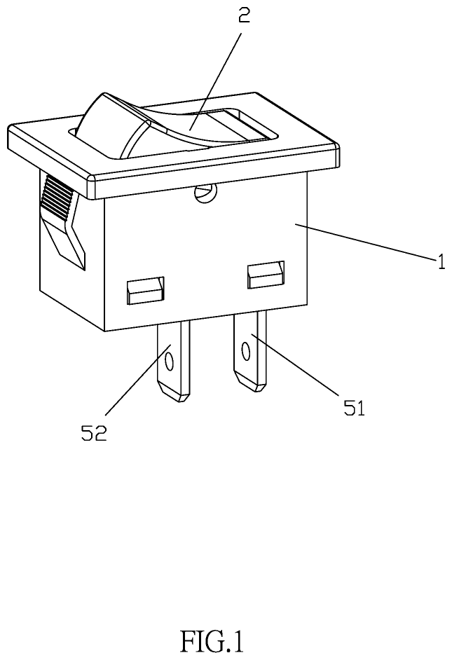

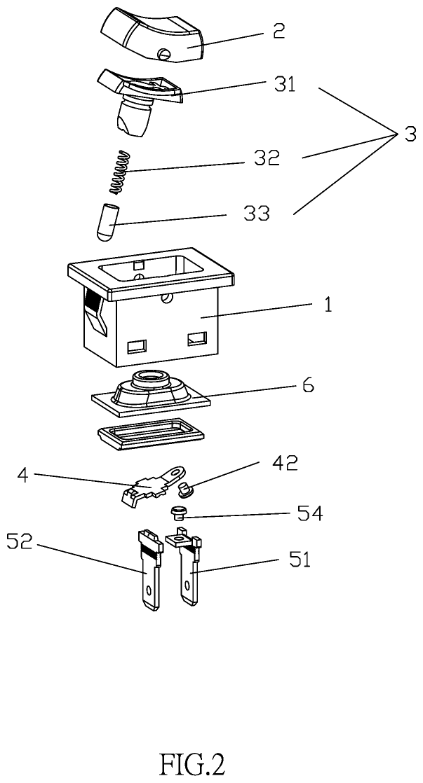

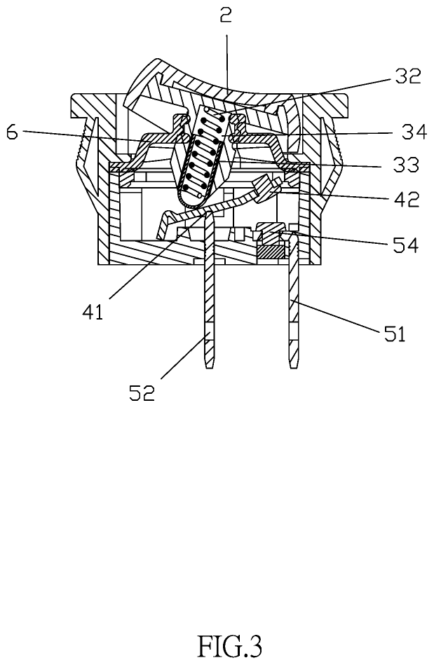

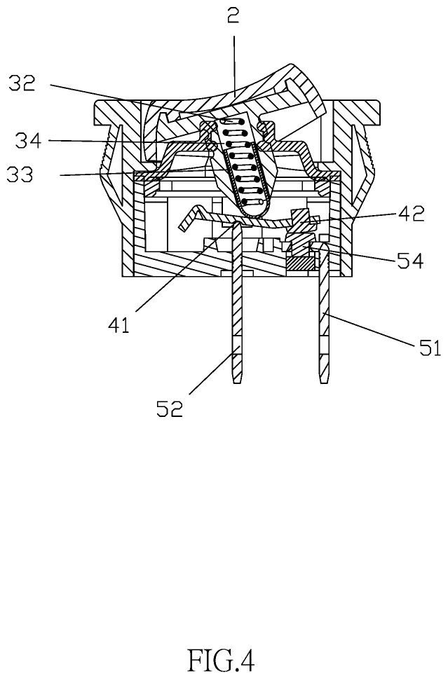

With reference to FIGS. 1 to 4 for a rocker switch in accordance with the first embodiment of the present invention, the rocker switch comprises a housing 1, a button 2, a rocker 3, a dynamic contact plate 4, and a first terminal 51 and a second terminal 52 installed in the housing 1, and the button 2 being hinged with the housing 1, and the top of the rocker 3 being coupled to the bottom of the button 2, and the rocker 3 and the button 2 being linked with each other, and a bottom side of the dynamic contact plate 4 pressing the second terminal 52, and the rocker 3 being provided for moving the dynamic contact plate 4 to rotate, and an end of the dynamic contact plate 4 being provided for coupling the first terminal 51.

The rocker switch of this embodiment has the following effect:

To overcome the issue of the rocker switch that cannot be miniaturized, the present invention provides a rocker switch, wherein the button 2 is hinged with the housing 1, and the rocker 3 is linked with the button 2, and the rocker 3 turns the dynamic contact plate 4 when the button 2 is pressed, and the top of the button 2 moves obliquely in a direction towards the first terminal 51 in a disconnected status. Now, the rocker 3 presses at the other end of the dynamic contact plate 4, so that an end of the dynamic contact plate 4 is separated from the first terminal 51. When the button 2 is pressed in a direction away from the first terminal 51, the top of the button 2 rotates in a direction away from the first terminal 51 while driving the rocker 3 to swing and press at an end of the dynamic contact plate 4, so that the dynamic contact plate 4 also swings, and an end of the dynamic contact plate 4 touches the first terminal 51 to set the rocker switch to a connected status. The rocker switch of the present invention can control the connection and disconnection without requiring a relay, so as to overcome the issue of the conventional rocker switch that cannot be miniaturized.

Specifically, the bottom of the rocker 3 presses at an end surface of the dynamic contact plate 4, and the other end surface of the dynamic contact plate 4 has a notch 41, and the notch 41 presses at the top of the second terminal 52. When the dynamic contact plate 4 is pressed by the rocker 3 to swing, the dynamic contact plate 4 can be rotated by using the notch 41 as a fulcrum to prevent the occurrence of displacement during the rotation of the dynamic contact plate 4.

Specifically, the rocker 3 comprises a rocking shaft 31, a spring 32 and a prop 33, and the top of the rocking shaft 31 is coupled to the bottom of the button 2, and the rocking shaft 31 and the button 2 are linked with each other, and the rocking shaft 31 has a chute 34, and the prop 33 is slidably coupled to the chute 34, and the spring 32 is installed between the chute 34 and prop 33, and an end of the prop 33 presses at an end surface of the dynamic contact plate 4.

After a swing of the button 2 has occurred, the rocking shaft 31 slides along the chute 34 of the rocking shaft 31, while the prop 33 under the action of the spring 32 always keeps pressing at the dynamic contact plate 4. In addition, the prop 33 is in a hollow shape, and both ends of the spring 32 are coupled to the bottom end surface of the chute 34 and the top of an inner sidewall of the prop 33 respectively, so that the spring 32 has the positioning and guiding effects.

Specifically, the top of the first terminal 51 has a first static contact 54, and an end of the dynamic contact plate 4 has a first dynamic contact 42 for contacting with the first static contact 54. When the first dynamic contact 42 and the first static contact 54 are contacted with each other, the first terminal 51 and the second terminal 52 are connected. In the meantime, the first dynamic contact 42 and the first static contact 54 can improve the contact effect between the dynamic contact plate 4 and the first terminal 51.

Specifically, a silicone sealing ring 6 is installed between the rocker 3 and the housing 1 for preventing dust from entering into the switch when rocker 3 is swung.

### Second Embodiment

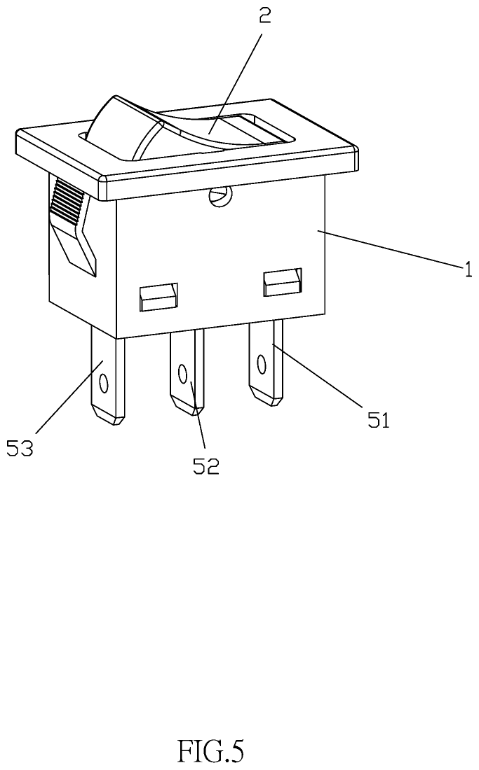

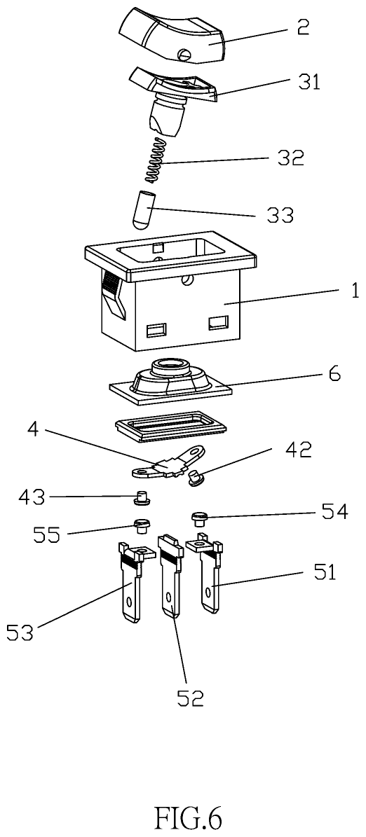

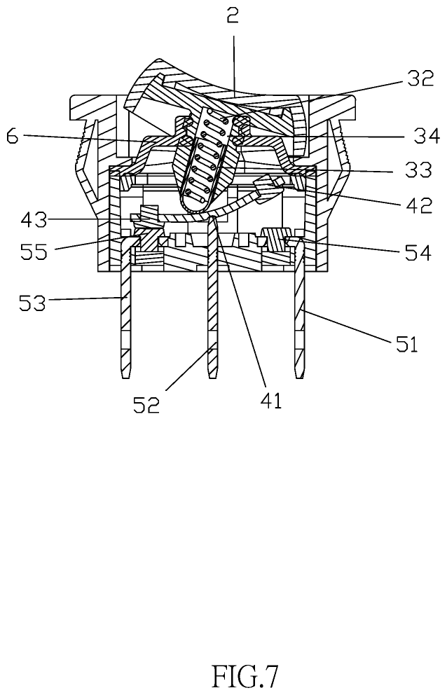

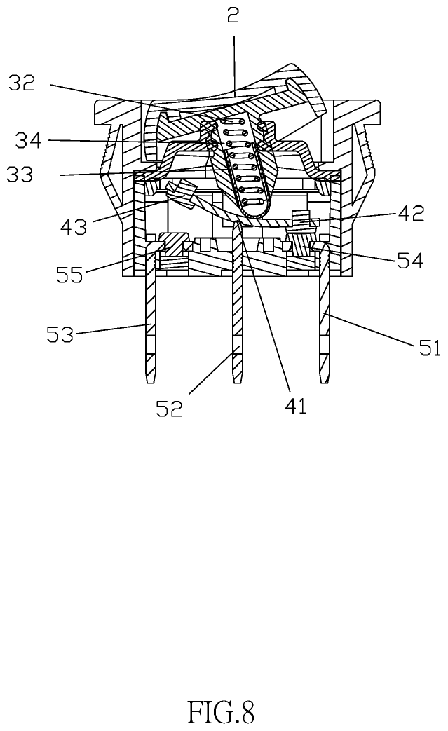

With reference to FIGS. 5 to 8 for a rocker switch in accordance with the second embodiment of the present invention, the rocker switch further comprises a third terminal 53, and the other end of the dynamic contact plate 4 is provided for coupling the third terminal 53, wherein the rocker switch of this embodiment has two connected statuses, and no disconnected status. Specifically, the button 2 is pressed in a direction towards the third terminal to connect the first terminal 51 and the second terminal 52; and the button 2 is pressed in a direction towards the first terminal 51 to connect the second terminal 52 and the third terminal 53.

Specifically, the top of the third terminal 53 has a second static contact 55, and the other end of the dynamic contact plate 4 has a second dynamic contact 43 provided for contacting with the second static contact 55. When the second dynamic contact 43 and the second static contact 55 are contacted with each other, the second terminal 52 and the third terminal 53 are connected. In the meantime, the second dynamic contact 43 and the second static contact 55 can improve the contact effect between the dynamic contact plate 4 and the third terminal 53.

It is noteworthy that the rocker switch of this embodiment is substantially the same as that of the first embodiment except the aforementioned technical characteristics. In addition, the way of pressing the button 2 to control the connection between the first terminal 51 and the second terminal 52, and the connection between the second terminal 52 and the third terminal 53 has been described in the first embodiment, and thus will not be repeated.

While the invention has been described by means of specific embodiments, numerous modifications and variations could be made thereto by those skilled in the art without departing from the scope and spirit of the invention as set forth in the claims.

What is claimed is:

1. A rocker switch with a housing (1), comprising: a button (2), a rocker (3), a dynamic contact plate (4), and a first terminal (51) and a second terminal (52) installed in the housing (1), and the button (2) being hinged with the housing (1), and the top of the rocker (3) being coupled to the bottom of the button (2), and the rocker (3) and the button (2) being linked with each other, and a bottom side of the dynamic contact plate (4) pressing the second terminal (52), and the rocker (3) being provided for moving the dynamic contact plate (4) to rotate, and an end of the dynamic contact plate (4) being provided for coupling the first terminal (51).

2. The rocker switch as claimed in claim 1, wherein the bottom of the rocker (3) presses at an end surface of the dynamic contact plate (4), and the other end surface of the dynamic contact plate (4) has a notch (41), and the notch (41) presses at the top of the second terminal (52).

3. The rocker switch as claimed in claim 1, wherein the rocker (3) comprises a rocking shaft (31), a spring (32) and a prop (33), and the top of the rocking shaft (31) is coupled to the bottom of the button (2), and the rocking shaft (31) and the button (2) are linked with each other, and the rocking shaft (31) has a chute (34), and the prop (33) is slidably coupled to the chute (34), and the spring (32) is installed between the chute (34) and prop (33), and an end of the prop (33) presses at an end surface of the dynamic contact plate (4).

4. The rocker switch as claimed in claim 3, wherein the prop (33) is in a hollow shape, and both ends of the spring (32) are coupled to the bottom end surface of the chute (34) and the top of an inner sidewall of the prop (33) respectively.

5. The rocker switch as claimed in claim 1, wherein the top of the first terminal (51) has a first static contact (54), and an end of the dynamic contact plate (4) has a first dynamic contact (42) for contacting with the first static contact (54).

6. The rocker switch as claimed in claim 1, further comprising a third terminal (53), and the other end of the dynamic contact plate (4) is provided for coupling the third terminal (53).

7. The rocker switch as claimed in claim 6, wherein the top of the third terminal (53) has a second static contact (55), and the other end of the dynamic contact plate (4) has a second dynamic contact (43) provided for contacting with the second static contact (55).

8. The rocker switch as claimed in claim 1, further comprising a silicone sealing ring (6) installed between the rocker (3) and the housing (1).
